(19) United States
(12) Patent Application Publication
(10) Pub. No.: US 2005/0004976 A1
(43) Pub. Date: Jan. 6, 2005

(54) Software apparatus and method to automatically detect videofile type for video server

(76) Inventors: Richard Mavrogeanes, Wallingford, CT (US); Scott McCoy, Startford, CT (US)

Correspondence Address: ALIX YALE & RISTAS LLP, 750 MAIN STREET, SUITE 1400, HARTFORD, CT, 06103, US

(21) Appl. No.: 10/613,234

(22) Filed: Jul. 3, 2003

(51) Int. Cl. G06F 15/16

(52) U.S. Cl. 709/203; 709/219

(57) ABSTRACT

A method and apparatus are disclosed for automating the task of adding video content to a video server. Instructions implemented in the video server cause the video server to automatically examine each new file added to the server to determine whether the new file contains a video program. If the new file contains a video program, the video server examines the data structure of the new file to determine the format used to encode the video program. The video server attaches an indication of the encoding format to the video program and adds the video program to a list of video content available to users having access to the video server. The video server is disclosed as accessible from a client computer over an IP network, although other arrangements are possible.

### BACKGROUND OF THE INVENTION

1. Field of the Invention

The invention relates to servers and, more particularly, to servers for storage and delivery of digitally encoded video files.

2. Description of the Related Art

Video servers are special purpose servers configured to receive, store and “play” video programs. Video programs stored on a server may be referred to as “video content” or “content”. Video servers are typically connected to a network in a manner that permits interaction with authorized users on the network. A graphical user interface on a client computer connected to the network allows the user to initiate server functions such as adding content to the video server and/or playing a selected item of content at a particular outlet connected to the network. The outlet may be a computer terminal or a video monitor equipped with a decoding device.

Herein, the term “video program” means a collection of related audio-video signals having a common time base and intended for synchronized presentation. Video programs are digitally encoded for transmission and storage and require decoding before playing. The format used to encode a digital video file must be identified so that the proper decoding steps may be taken to provide the best quality playback. There are many possible formats in which a digital video file may be encoded. Among the possible formats are standard formats established by the moving pictures expert group (MPEG), including MPEG-1, MPEG-2, MPEG-4 and a future MPEG-7. Using the proper format to decode and play a video program is a process that is known in the art and will not be discussed further herein. The combination of hardware and software used to decode and deliver a video program for viewing is sometimes referred to as a “video pump”.

The tasks necessary to maintain content on a video server can be generally discussed under concept of “content maintenance”. Content maintenance includes the task of adding new content to the video server. Currently, adding new content to a video server requires manual intervention before the new content is available for use. Typically, the video program must be downloaded to the video server. After download, an operator must provide the video server with information about the new video program, including the format in which the video program is encoded, the category in which the video program is to be stored, the size of the video program, and the like. The new video program must then be added to a list of available content that is presented to users via the graphical user interface. Only after these manual steps will the new content be available for use. The need for manual intervention is inconvenient and frequently results in delay in the availability of new content to users having access to a digital video server. Program information inputted manually is also subject to errors.

There is a need in the art for a simplified and streamlined video server that decreases the need for manual intervention in the process of adding new content to a video server and makes new content available more quickly.

### SUMMARY OF THE INVENTION

Briefly stated, one preferred embodiment of the present invention comprises a video server that automatically performs several operations on files containing new video programs delivered to the server. In accordance with one aspect of the present invention, the automatic operations substantially eliminate the need for manual intervention in the task of adding video programs to the available content on a video server.

By various means a new file may be placed on the video server. If the file contains a video program, the server takes steps to determine the format in which the video program was encoded. In accordance with a further aspect of the present invention, the video server creates an information file for each new video program. The video server places pertinent characteristics of the video program in the information file.

The presence or absence of an information file associated with a particular video program helps the video server to quickly differentiate existing content from newly arrived files potentially containing new content.

Non-video content or video content encoded in formats the server is not equipped to decode is rejected. Assuming the new file contains a video program encoded in a format the server is equipped to handle, the new content and its associated information file are immediately and automatically added to a list of available content displayed in the graphical user interface. Typically, the above described process will take approximately five seconds or less. That is, from the completion of the download of a new video program to availability of the new video program to users takes less than five seconds.

The process of adding new content to a video server is significantly simplified because no manual intervention is required other than that of initiating the download of a new file to the server. The accuracy of video program format data is improved by removing human intervention from the data input process.

### BRIEF DESCRIPTION OF THE DRAWINGS

FIG. 1 is a diagram of a typical network architecture incorporating a video server in accordance with the present invention;

FIG. 2 is a flowchart depicting representative steps in the automated content addition process carried out by a video server in accordance with the present invention; and

FIG. 3 is a schematic block diagram of one computer architecture appropriate for implementation of the present invention.

### DETAILED DESCRIPTION OF THE PREFERRED EMBODIMENT

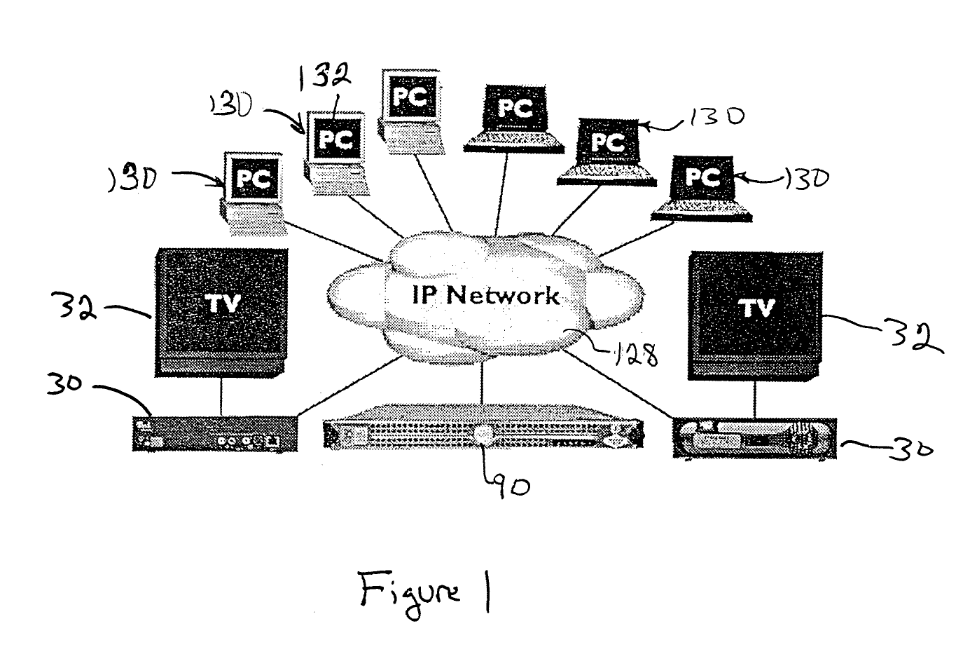

With reference to the drawings, FIG. 1 illustrates a representative IP network 128, such as the Internet, connecting a video server 90 to client computers 130 and video outlets 30, 32. Each of the client computers 130 includes a display 132, input devices such as a keyboard and/or a mouse, electronic storage 134 and processing capability typical of known computers. Video programs played by the video server 90 may be viewed on a client computer display 132 or a television monitor 32 equipped with a video decoder 30.

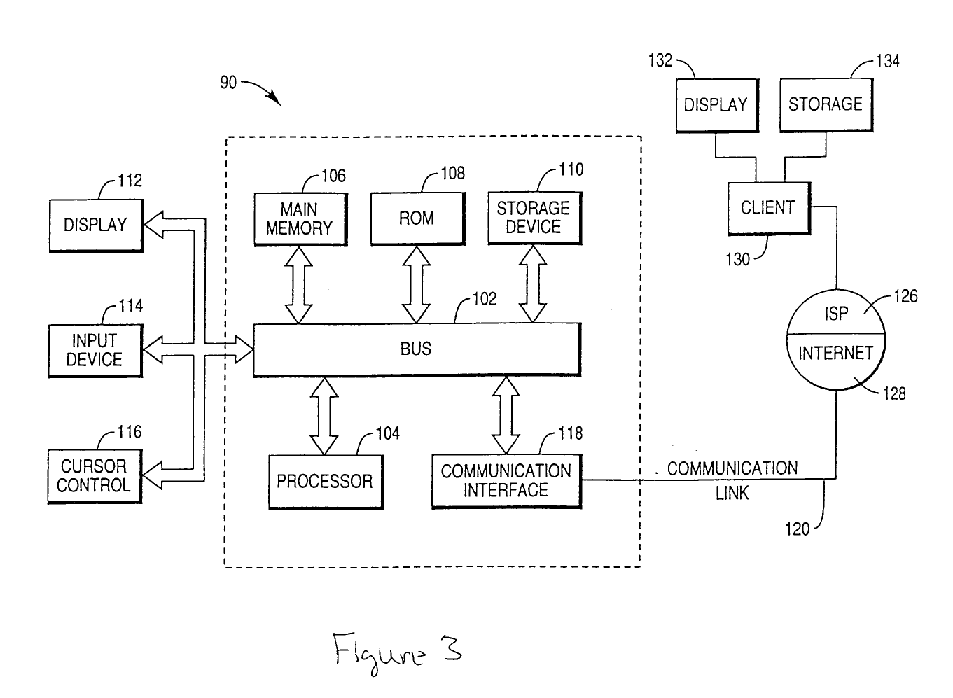

FIG. 3 illustrates a basic server computer 90/client computer 130 architecture suitable for implementation of the present invention. The server computer 90 includes a processor 104 for carrying out instructions stored in one of the ROM 108 and/or Main Memory 106. A storage device 110 is provided for storage of video content. The storage device will typically comprise one or more hard disc drives (not shown).

The server computer 90 may have its own display 112, input device 114 (such as a keyboard) and cursor control 116 (such as a mouse). It is typically not necessary to provide a server computer with its own display, input and cursor control devices because all the functions of the server are accessible by means of a client computer 130 connected to the server computer 90 through a communications interface 118/communication link 120 as is known in the art. FIG. 3 shows the client computer 130 connected to the internet 128 through an internet service provider (ISP) 126. Other IP network connections, such as a local area network (LAN) or wide area network (WAN) are also compatible with the present invention. The client computer 130 will typically be a PC having a display 132 and electronic storage 134.

Among the most widely used standards for the compression (encoding) of digital audio video programs for storage and transmission are those promulgated by the moving pictures experts group (MPEG). Of the MPEG standards, the most popular are the MPEG-1 and MPEG-2 standards. Several varieties of MPEG-2 compression are currently in use. MPEG-4 and MPEG-7 standards will be used in the future. To properly decode and play a video program, the same format used to encode the program must be used to decode and play the video program. Use of the wrong format will either make playing the video impossible or adversely effect the quality of the video playback.

As discussed above, new content is typically added to a video server by a series of manual steps. An administrator will typically provide the video server with information about each new item of content including information regarding the applicable compression scheme. Until the video server is provided with this information, new content is not available for users having access to the video server. Further, information regarding new content may be incorrectly entered resulting in playback error.

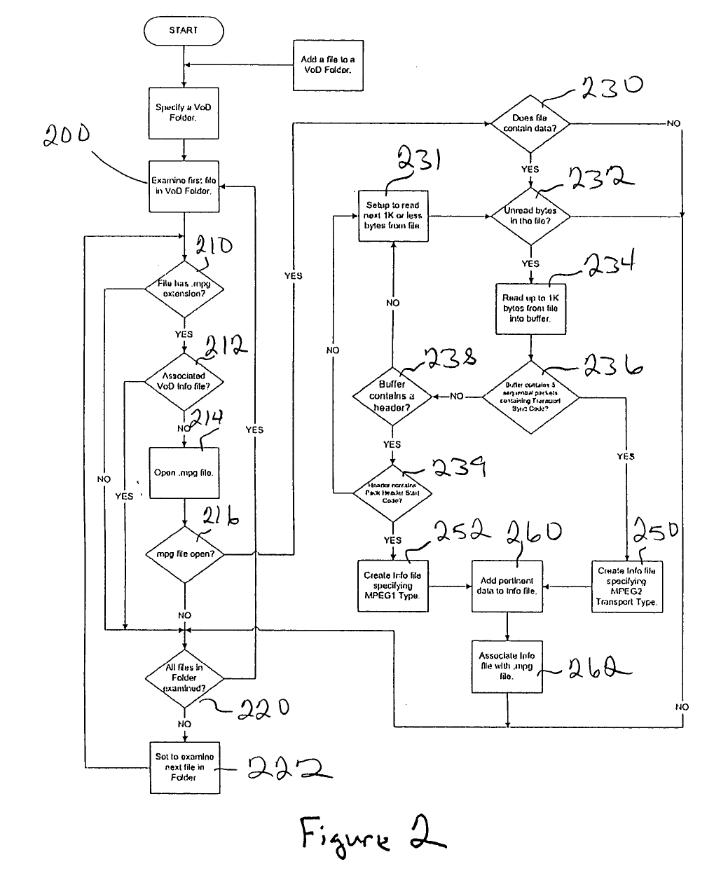

FIG. 2 illustrates a portion of a representative software program in accordance with aspects of the present invention. In accordance with an aspect of the present invention the video server software:

detects the presence of a new file;

extracts portions of the file;

examines the extracted portions to determine the compression scheme;

creates an information file including compression information about the new video program;

associates the information file with the new video program; and

adds the new video program and its associated information file to a library of available content on the video server.

A video server may be understood as a computer configured for the storage and delivery of video programs. The video server comprises processing, memory and communications components selected to be compatible with the task of video storage and delivery. Video programs may be quite large, so an important component of the video server is a large capacity electronic storage system. Another component of the video server is a video “pump” that decodes and delivers video files to a designated location for viewing. The video server also includes a user interface to allow human interaction. The file storage system may comprise one or more magnetic disc drives. Alternatively, solid state memory may be used for this function.

Interaction with the video server is managed through a graphical user interface as is typical in the art. The graphical user interface may include an Active Server Page (ASP) that accesses a video file directory on the video server. Access to the video file directory allows an authorized user to add or delete video programs, organize video programs, restrict access to certain of the video programs and play video programs to a particular destination. Typically, the video server 90 is connected to an Internet protocol (IP) network, although other network formats are possible. The graphical user interface of the video server is opened by addressing the video server through browser programs such as Internet Explorer™ or Netscape Navigator™ that are generally available for operation on an IP network. When the automated steps for adding new content are complete, the ASP generates HTML content listing the available content and delivers the HTML to the client computer 130.

The present invention relates to the addition of new content to the available content on a video server. More particularly, the present invention relates to a video server that manages the addition of new video programs to the available video content. A video server exemplary of aspects of the present invention operates in the environment illustrated in FIG. 1. The video server 90 has an address on the IP network 128. The available content on the video server 90 is organized into folders according to an organizational scheme established by an administrator. An authorized user on a client computer 130 establishes a connection with the video server 90 by means of a web browser. The video server 90 presents its graphical user interface to the authorized user. The user then chooses the destination for the new content by opening a folder of the video server 90. An object containing new content is dragged and dropped into the designated folder. Alternatively, the object containing new content may come from a disc inserted in a drive of the client computer 130. It will be understood that drag and drop or use of a disc are examples of sources for new content. Any means of loading new content to the video server is compatible with the present invention.

The only manual steps required for the addition of new content to the video server 90 are those required to put the new content into a folder of the video server. Upon detecting a new object in a folder, the video server 90 is programmed to examine the object, determine the scheme under which any video content was encoded, produce an information file containing the compression scheme information and attach or associate the information file with the object. The information file may be displayed to the user depositing the new content. The object is added to the content available to users of the video server. All of this activity takes place automatically and without intervention by the user or a system administrator. This approach to adding content to a video server reduces the error associated with manually inputted information and virtually eliminates the delay between arrival of new content and its availability to users.

FIG. 2 is a flowchart of representative program steps of an exemplary software program resident on a video server for determining the format used to encode video content, creating an information file specifying the encoding format, associating the information file with the new video content and adding the new video content to the available content on the video server.

The flowchart begins with the addition of a new file to a designated folder on the video server. The program then includes steps for opening and examining each file in the designated folder as shown in the left-hand portion of FIG. 2, steps 200, 210, 212, 214, 220 and 222.

The illustrated program is configured to examine only files having a .mpg extension (step 210). The mpg extension indicates the video content is encoded using one of the MPEG formats. Similar programs may be configured to open and handle many different types of video formats.

The program recognizes existing content by the information files (VoD Info file) previously associated with each item existing content at step 212. If the file has an Info file, the program skips to the next file in the folder at steps 220 and 222. If a file is identified as new content, steps 212 and 214 open the .mpg file, which is further examined in the right-hand portion of FIG. 2 at steps 230 through 239.

The program extracts up to one kilobyte of data from the file into a buffer at step 234. The program then examines the data in the buffer to determine which MPEG format was used to encode the video by looking at the structure of the data. An MPEG-2 transport type encoded video file will contain five sequential packets containing Transport Sync Code. If the program identifies such a data structure at step 236, the video was encoded using the MPEG-2 transport type standard and an information file specifying MPEG-2 is created at step 250. If the data in the buffer is not in a structure indicative of the MPEG-2 standard, the program determines whether the buffer contains a header at step 238. If there is a header and the header contains a Pack Header Start Code (detected at step 239), this indicates that the video was encoded using the MPEG-1 standard and an information file specifying MPEG-1 is created at step 252. If the first data chunk does not provide evidence of the encoding format, one k-byte units of data are extracted from the file until one or the other formats are identified (steps 231, 232). The information files are associated with the video programs at steps 260, 262. If the entire file is examined without determining the format, an information file cannot be created that will allow the video server to play the file, and the file will not be added to available content.

A representative format for an information file name may be to use the name of the mpg file with the suffix .txt. For example, if the .mpg file was named “Mymovie.mpg”, then the associated information file would be named “Mymovie.txt” (step 262). Examples of data included in an information file are:

Filename: Mymovie.mpg

Type: MPEG1

Location: VoDServer\E:\Vod Folders\Folder

Category:

Date: 1/1/2003

Description:

Runtime:

User rating:

Related:

The filename, type, location, date and runtime fields are filled out automatically by the video server program. The step of adding pertinent data to Info file 260 may include presenting the information file to the person adding new content so they can complete the category, description, user rating and related fields. Manual intervention to complete information file fields that are not automatically completed by the server program is not necessary for the content associated with the information file to be available for use. This information may be added later or left blank.

The above described program steps illustrate a representative portion of an exemplary program that implements the invention. The representative program steps may be expanded so that the video server could handle video files ending in extensions other than .mpg. Further, the program steps may be modified to permit the video server to handle other MPEG formats such as MPEG-4 and the future MPEG-7 format.

The invention is discussed in the context of an IP network where the graphical user interface of the video server is accessed using a web browser equipped client computer. Other arrangements are known in the art for implementing a communications interface between a server and a client computer, such as local area networks and wide area networks. An upload interface in the form of a drag and drop interface has also been discussed. New content may also be added to a folder of a video file storage system locally by means of a disc drive, video equipment, etc.

While a preferred embodiment of the foregoing invention has been set forth for purposes of illustration, the foregoing description should not be deemed a limitation of the invention herein. Accordingly, various modifications, adaptations and alternatives may occur to one skilled in the art without departing from the spirit and the scope of the present invention.

1. A computer-implemented method of rendering digital video content accessible through other client computers running a web browser, said method comprising the steps of:
receiving a file deposited in a folder of a video server by an authorized user;
opening the file and examining the file to determine:
whether the file contains video content; and
if the file contains video content, the encoding format for the video content;
generating an information file containing an indication of the encoding format for the video content;
associating the information file with the video content; and
adding the video content to a listing of available content,
wherein the steps of opening, generating, associating and adding are carried out automatically such that the video content is available for viewing by a user upon completion of said step of adding.

2. The method of claim 1, comprising the step of:
automatically presenting the information file to the authorized user, wherein said authorized user is allowed to complete fields of the information file to describe the video content.

3. The method of claim 1, wherein said step of associating comprises:
giving the information file a filename identical to that of the video content, said filename being followed by a different extension.

4. A video server comprising:
a communications interface for exchange of data between the video server and a client computer over a network;
a file storage system for storing a plurality of files containing video content;
a software program that manages reception of new video content, storage of video content, decoding and playback of video content according to a selected one of a plurality of industry standard formats; and
a user interface displayable on a display of the client computer whereby a user interacts with the software program to add new video content to the file storage system, delete video content from the file storage system, and/or select a particular item of video content for playback to a selected destination,
wherein the software program manages reception of new video content by automatically:
examining a new file to identify which of said plurality of industry standard formats was used to encode the new video content contained in the new file;
attaching an information file to the new file indicating the identified industry standard format; and
placing the new file in a list of available video content selectable by a user through the user interface.

5. The video server of claim 4, wherein the software program automatically:
presents the information file to the user, whereby the user is able to complete fields in the information file that describe the new video content.

6. The video server of claim 4, comprising a video pump that decodes and delivers video content selected for playback by a user and wherein the software program automatically:
presents the information file to the video pump,
whereby the video pump uses the identified industry standard format to decode and deliver video content in the file associated with the information file.

7. The video server of claim 4, wherein said industry standard format is an MPEG format.

8. An article comprising:
at least one sequence of machine readable instructions;
a medium bearing the executable instructions in computer readable form, wherein execution by a server computer causes the server computer to:
display a user interface on a client computer display, said client computer and said server computer connected by means of a network;
receive a new file from the client computer and automatically:
examine the new file to determine if the new file contains a video program and if the new file contains a video program;
examine the data structure of the new file to determine which of a plurality of formats was used to encode the video program;
associate an indication of the format used to encode the video program with the video program;
store the video program and indication on the server computer so that the video program is accessible by client computers authorized to establish a connection with the server computer; and
add the video program to a list of available content viewable on a client computer display by means of the user interface.

9. The article of claim 8, wherein said formats include formats promulgated by the moving pictures experts group (MPEG).
